(19) United States
(12) Patent Application Publication
(10) Pub. No.: US 2016/0080455 A1
(43) Pub. Date: Mar. 17, 2016

(54) DELIVERY DEVICE, REPRODUCTION DEVICE, AND DELIVERY SYSTEM

(71) Applicant: KABUSHIKI KAISHA TOSHIBA, Minato-ku (JP)

(72) Inventors: Takayuki ITOH, Kawasaki (JP); Akiyuki TANIZAWA, Kawasaki (JP); Jun YAMAGUCHI, Kawasaki (JP); Tomoya KODAMA, Kawasaki (JP); Takeshi CHUJOH, Kawasaki (JP); Shunichi GONDO, Ota (JP)

(73) Assignee: KABUSHIKI KAISHA TOSHIBA, Minato-ku (JP)

(21) Appl. No.: 14/853,432

(22) Filed: Sep. 14, 2015

(30) Foreign Application Priority Data
Sep. 12, 2014 (JP) 2014-186566

(51) Int. Cl. H04L 29/06

(52) U.S. Cl. CPC H04L 65/607; H04L 65/4069; H04L 65/80

(57) ABSTRACT

A reproduction system according to an embodiment includes a communicator which communicates information including an encoded data and a processor. The processor is configured to select the encoded data to be delivered, send a request an external delivery device to deliver a third encoded data until a starting time of following segment included in a second encoded data via the communicator when the second encoded data is selected to be delivered following to a first encoded data, and decode the encoded data received by the communicator. The second encoded data and the third encoded data are generated by encoding a first content.

### CROSS-REFERENCE TO RELATED APPLICATION

This application is based upon and claims the benefit of priority from Japanese Patent Application No. 2014-186566, filed on Sep. 12, 2014, the entire contents of which are incorporated herein by reference.

### FIELD

Embodiments described herein relate generally to a device to deliver content, a device to reproduce the content, and a system including the devices.

### BACKGROUND

Previously there is a device and a system to reproduce content delivered from a server over a network. In such system, for example according to a change in bandwidth of a network or a direction by the user, the content there approach is a method (adoptive streaming method) to switch qualities or kinds of the content adoptively.

For example, the content is divided into segments and encoded in a plurality of bit rates and stored in server. A previous reproduction device switches bitrates of the content to be delivered by segment according to a bandwidth of the network. The previous system adoptively controls quality of the content according to the bandwidth of the network. Switching a kind or quality of the content is done at a beginning time of each segment constituting the content stored in the server. Thus a delay in delivery of the content requested by the user up to the length of the segment occurs. A latency time can be reduced by shortening the segment. On the other hand, each segment needs to be reproduced by itself. Shortening the segment leads to a decrease in coding efficiency.

### BRIEF DESCRIPTION OF THE DRAWINGS

FIG. 1 is a diagram illustrating a system configuration according to embodiments.

FIG. 2 is a schematic diagram illustrating an example of a timing chart of each segment included in the encoded data A and B.

FIG. 3 is a schematic diagram illustrating an example of a timing chart of each segment included in the encoded data A and B.

FIG. 4 is a schematic diagram illustrating an example of a timing chart of each segment included in the encoded data A, B, and C.

FIG. 5 is a block diagram illustrating a delivery device according to a first embodiment.

FIG. 6 is a block diagram illustrating a reproduction device according to the first embodiment.

FIG. 7 is a flow chart illustrating operations executed by a system according to the first embodiment.

### DETAILED DESCRIPTION

Various embodiments will be described hereinafter with reference to the accompanying drawings. Items common to the embodiments will be given common reference symbols and will not be described redundantly.

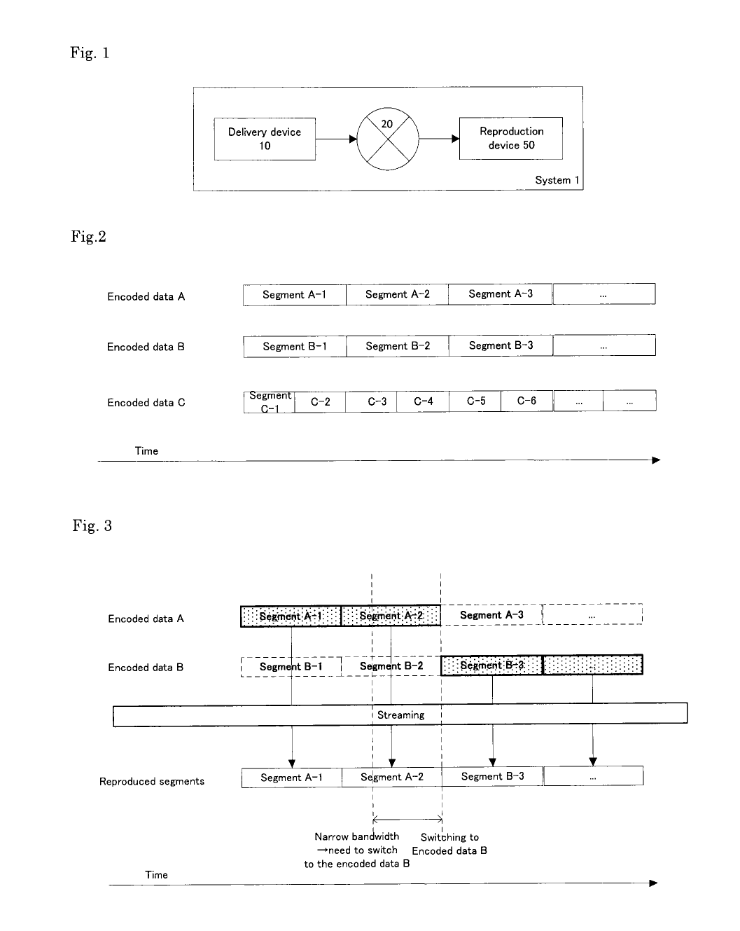

FIG. 1 is a block diagram illustrating a system of each embodiment. A system 1 includes a delivery device 10 and a reproduction device 50. The delivery device 10 and the reproduction device 50 are connected each other via a network 20. The network may be a wired or wireless transmission line which transmits information sent by devices connected wirelessly or wired with the network.

The delivery device 10 encodes content and stores encoded data of the content. The content may be an image and/or audio. The image may be a still picture or a moving picture. The audio may be speech or music. In following embodiments, an example that the content is a moving picture is described. The delivery device 10 sends the encoded data to the reproduction device 50 according to a request of the reproduction device 50. The reproduction device 50 receives the encoded data and decodes the encoded data to reproduce the content.

### First Embodiment

In an first embodiment, an example that the delivery device 10 generates the encoded data in a plurality of bit rates from the same content is described. The reproduction device 50 receives the encoded data, decodes the encoded data, and reproduces the content. The reproduction device 50 selects the encoded data to be delivered according to the bandwidth of the network.

FIG. 2 is a schematic diagram showing the encoded data generated by the delivery device 10 according to the first embodiment. The delivery device 10 generates encoded data A-C. The encoded data A is higher bit rate than the encoded data B. Contrary to the example disclosed above, the encoded data A may be encoded at a lower bit rate compared to the bit rate of encoded data B.

The encoded data A-C are respectively divided into segments. Each segment is encoded in a form that can be accessed directly. For example, the encoded data A can be decoded in order of “A-1”, “A-2”, “A-3.” Also, each segment has at least one random access point, and the encoded data “A-2” can be decoded without decoding “A-1.” If the content is encoded according to H.264/AVC, each segment in the encoded data is encoded as to start with IDR (Instantaneous Decoding Refresh) picture. The IDR picture is a type of I-frame. If the content is encoded according to H.264/AVC, all subsequent transmitted slices in an IDR picture can be decoded without reference to frames decoded prior to the IDR picture. An IDR picture specifies that no frame after the IDR frame can reference any frame before it.

By this encoding, each segment has a random access point.

The segments included in the encoded data C are temporally shorter than the segment included in the encoded data B. The encoded data C has frequent random access points compared to the encoded data B. The encoded data C may be encoded in any bit rate. Typically, the encoded data C is encoded at a bit rate identical with or similar to the bit rate of the encoded data B, so that favorable conditions for the current bandwidth can be provided.

The delivery device 10 stores the encoded data. The encoded data is sequentially delivered according to requests from the reproduction device 50 by the delivery device 10. The reproduction device 50 sequentially reproduces the encoded data delivered by the reproduction device 50.

The encoded data delivered by the delivery device 10 is selected preferably according to the bandwidth of the network. The reproduction device 50 sends a request to the delivery device 10, if the bandwidth of the network is sufficiently broad to deliver a high bit rate (value or range) (i.e. the segment included in the encoded data A), to deliver the segment having the high bit rate. The request may be sent only when the reproduction device 50 determined that it is necessary to switch encoded data. In that case, the request may include information specifying the encoded data to be delivered or notifying switch is required. Alternatively the request may be sent periodically. In that case, the request includes information specifying the encoded data to be delivered.

The reproduction device 50 sends a request to deliver the segment encoded at a low bit rate (value or range) (typically the segment included in the encoded data B) to the delivery device 10 if the bandwidth of the network is insufficient to deliver the segment at a high bit rate (typically the segment included in the encoded data A).

FIG. 3 is a schematic diagram for explaining switching between the encoded data A and the encoded data B. Encoded data A and B are randomly accessible segment by segment as illustrated in FIG. 3. Encoded data can be switched over to another encoded data at the starting time of the segment of encoded data to be reproduced later (for example, A to B). To switch to another encoded data at a time other than the starting time of the following segment of the encoded data, a latency time until the starting time of the following segment is required. As a length of each segment becomes shorter, the content can be switched more frequently. Generally shortening the segment causes a decrease in coding efficiency in the same bit rate. Also the reproduced content is deteriorated.

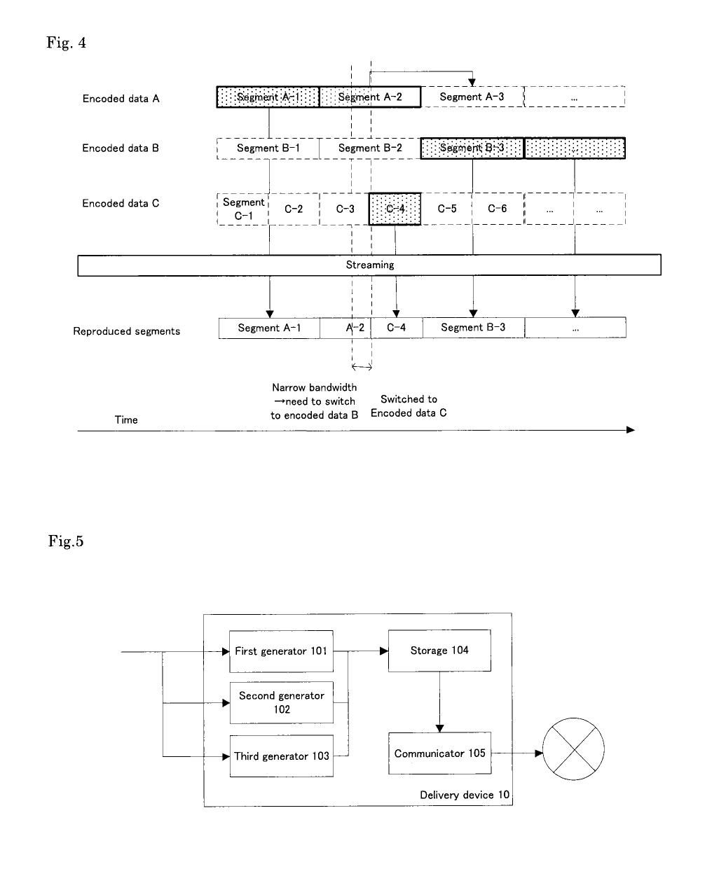

In the first embodiment, by using additionally the encoded data C a latency time to switch between the encoded data can be reduced. FIG. 4 shows an example that uses the encoded data C between the encoded data A and B.

An example where encoded data A encoded at a high bit rate, and encoded data B and the encoded data C encoded at a low bit rate are prepared is described below. Each segment of the encoded data C is shorter than that of the encoded data B. Accordingly in the case of switching from encoded data A to encoded data B, temporarily encoded data C is used. Thereby the latency time to switch from the higher bit rate to the lower bit rate can be reduced.

If a timing to switch the encoded data is sufficiently close to the starting time of the segment of encoded data B, encoded data B may be directly reproduced without switching to encoded data C. For example, if a difference between the timing to switch the encoded data and the timing of the segment of encoded data B is shorter than a predetermined threshold, encoded data B may be directly reproduced without switching to encoded data C. The threshold may be from 0 (sec) to a length of one segment of encoded data C.

The length of one segment of encoded data C may be various lengths as long as one segment of encoded data C is shorter than that of encoded data A or B. In the example described above, encoded data A has a high bit rate, and encoded data B has a low bit rate. The example can also be applied in the case where encoded data A has a low bit rate and encoded data B has a high bit rate. In this instance, the latency time to switch from low bit rate to high bit rate can be reduced. A timing to decide to switch encoded data A (low bit rate) to encoded data B (high bit rate) is different from a starting time of following segment of encoded data B, encoded data C of which segment starts earlier is delivered.

Additionally encoded data D having segments shorter than the segments of encoded data A may be prepared. Encoded data D is made from the same content of the encoded data A. By doing so, in both cases of switching from the high bit rate to the low bit rate and switching from the low bit rate to the high bit rate, the latency time can be reduced.

Encoded data C may be encoded so as to have an intermediate bit rate between a bit rate of encoded data A and a bit rate of encoded data B. In that case, a length of each segment of encoded data C is shorter than encoded data A and B. By temporarily reproducing encoded data C which has a low bit rate compared to encoded data A during an interval between encoded data A and encoded data B, the latency time to switch to the lower bit rate can be reduced. Also, in the case of switching from encoded data B to encoded data A, temporarily encoded data C can be used. In that case, encoded data C has a higher bit rate compared to that of encoded data B, and the latency time required to increase the bitrate of the content can be reduced.

As described above, by using encoded data C the latency time to switch the encoded data can be reduced without shortening encoded data A and B. Even if the length of the segment of encoded data A and B becomes longer, the latency time to switch between the encoded data does not increase by preparing encoded data C having a shorter segment. Generally as the length of the segment included in the encoded data becomes longer (typically lengthening an interval between random access points), efficiency in encoding the content increases. Therefore the quality of reproduced content is increased in the same condition of the bit rate of encoded data A and B.

When the bandwidth of a network is stable, either of encoded data A or B which is selected at first is continuously delivered. For example, in case that the bandwidth of the network is consistently greater than a bit rate sufficient to deliver encoded data A, the network is stable to deliver the encoded data A. In case that the bandwidth of the network is consistently between a bit rate sufficient to deliver encoded data A and B, the network is stable to deliver the encoded data B. In such a situation, the encoded data is less likely to be switched. In such a case, by preparing encoded data C, the quality of reproduced content of encoded data B and/or encoded data A can be increased.

Each element included in the system 1 is disclosed below. FIG. 5 is a block diagram illustrating the delivery device 10. The delivery device 10 includes a first generator 101, a second generator 102, a third generator 103, storage 104, and a communicator 105.

The first generator 101 generates encoded data A by encoding the received content. The first generator 101 sends encoded data A to storage 104. The second generator 102 generates encoded data B by encoding the received content. The bit rate of encoded data B is lower than the bit rate of encoded data A. The second generator 102 sends encoded data B to storage 104.

The third generator 103 generates encoded data C by encoding the received content. Encoded data C is encoded so that the segment length is shorter than the length of the segment of encoded data A and encoded data B. The third generator 103 sends encoded data C to the storage 104.

The first generator 101, the second generator 102, and the third generator 103 may generate meta-information about each encoded data along with the encoded data. For example, the bit rate, resolution, or frame rate may be generated as the meta-information. Also additional information necessary to access (for example, a name of a file, a byte offset, a size of the segment, or an interval between segments) the segment of the encoded data may be generated. Generated information is sent to the storage 104, along with the encoded data.

The storage 104 receives encoded data A-C respectively from the first generator 101, the second generator 102, and the third generator 103 and stores encoded data A-C. The storage 104 may be any kind of storage media, for example non-volatile memory, magnetic hard disk, or optical disk. Encoded data A-C may be stored in any kind of file format of a multimedia container. The multimedia container is a file format for storing the encoded data. An existing multimedia container, for example MPEG-2 System, MP4 (MPEG-4 Part 14), and ASF, may be used. Each encoded data includes the segments. Each segment may be treated as one file. Also, plural segments may be treated as one file. If the first generator 101, the second generator 102, and the third generator 103 generate the meta-information or the additional information, the generated information may be saved in any kind of multimedia container. Also the generated information may be saved as a separate file from the encoded data.

The communicator 105 acts as an interface between the reproduction device 50 and the delivery device 10. The communicator 105 communicates with the reproduction device 50 over the network the reproduction device 50. The communicator 105 executes data requested by the reproduction device 50 from the storage 104, and sends the executed data to the reproduction device 50. For example, the communicator 105 receives information identifying the segment from the reproduction device 50 and sends the identified segment to the reproduction device 50. The information identifying the segment may be an ID number of the segment or byte offset. For example, the information identifying the segment may include information identifying the content. The information identifying the content may be an ID number of the content or name of the content.

Communicator 105 may be a HTTP (Hypertext Transfer Protocol) server and receive a request based upon HTTP from a HTTP client (the reproduction device 50). Also, the communicator 105 may receive the meta-information related to each encoded data and/or information necessary to access the segment included in the encoded data in the storage 104 from the reproduction device 50. The information necessary to access the segment may be sent to the reproduction device 50.

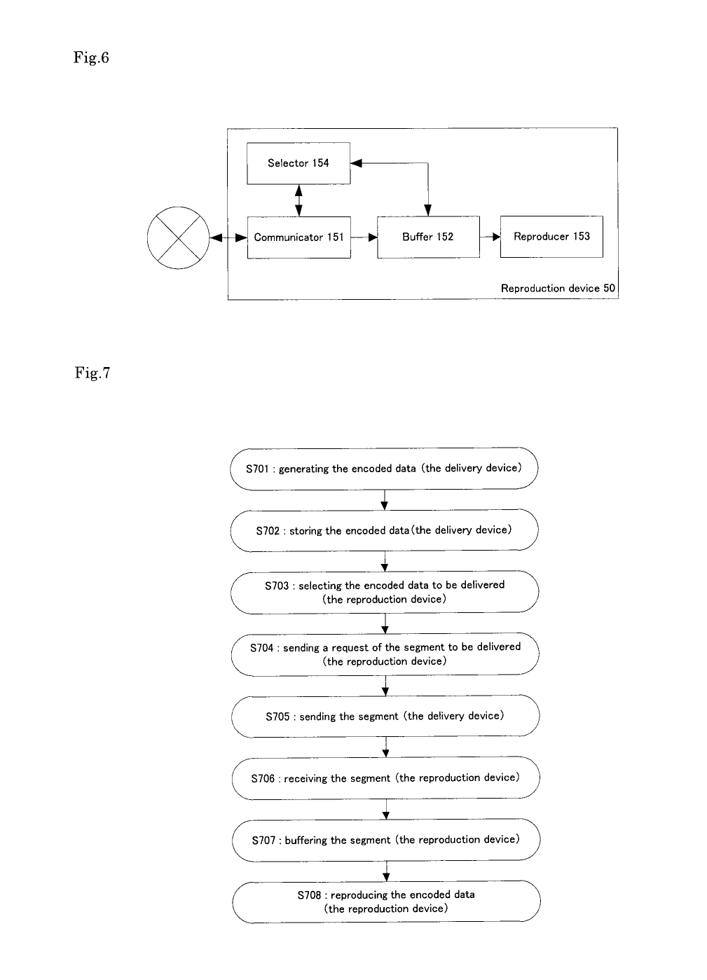

FIG. 6 is a block diagram illustrating reproduction device 50. Reproduction device 50 includes a communicator 151, a buffer 152, a reproducer 153, and a selector 154. Communicator 151 communicates with delivery device 10 via network 20. Communicator 151 may send information identifying an intended segment to delivery device 10 and receive the identified segments. Also, communicator 151 may send the requests according to HTTP to delivery device 10 and receive a response from a HTTP client. Communicator 151 receives encoded data from delivery device 10, and sends encoded data sequentially to buffer 152.

Buffer 152 sequentially receives encoded data from communicator 151 and buffers the received encoded data. The encoded data stored in buffer 152 is sequentially output to reproducer 153 according to FIFO (First In First Out) order.

Reproducer 153 sequentially receives encoded data from buffer 152 and reproduces the received encoded data. For example, reproducer 153 reproduces the encoded data by decoding the encoded data, D/A conversion, and/or rendering.

Selector 154 sequentially determines which of the encoded data is to be delivered according to network conditions and sends information indicating a result of selection to the communicator 151. Communicator 151 obtains part of the encoded data (i.e. the segment) from the delivery device 10 according to the information that communicator 151 received.

If the bandwidth of the network is sufficiently broad for delivering the encoded data A, selector 154 selects encoded data A having the higher bit rate. If not, the selector 154 selects encoded data B having the lower bit rate. For example, when the bandwidth of the network is P (P>1) times broader than the bit rate of encoded data A, or the bandwidth is broader than the bit rate of encoded data A by a predetermine value, the selector 154 selects encoded data A.

The bandwidth of the network may be derived from an amount of data that communicator 151 received during a given period of time. Otherwise, the bandwidth of the network may be derived from an amount of data buffered by buffer 152. As the bandwidth of the network increases, an amount of data buffered by buffer 152 increases. In this case, selector 154 determines the encoded data to be delivered according to the amount of the data buffered by buffer 152. For example, selector 154 selects encoded data A if an amount of buffering data exceeds a predetermined threshold. The threshold may be a sum of a minimum data amount to deliver encoded data A and an arbitrary amount (more than 0).

When selector 154 decides to switch to other encoded data, selector 154 temporarily selects encoded data C. As described above, the segment length of encoded data C is short compared to the segment lengths of encoded data A and B. The interval between the starting point of encoded data A or B and C is shorter than the interval between the starting point of encoded data A and encoded data B. Therefore the encoded data can be switched with less latency time.

Communicator 151 sends a request for sending the segment included in the encoded data selected by selector 154 to delivery device 10 and sequentially receives the segment. Information necessary to identify the segment (for example a name of a file, an interval between the segments, or byte offset and size of each segment) is set previously by reproduction device 50 or is sent by delivery device 10 over network 20 previously. The information which is necessary to specify the encoded data (for example, bit rate of each encoded data, information indicating a starting time of the segment (information of time stamp, or the interval between the segments) may be obtained in the same way as the request.

FIG. 7 is a flow chart illustrating operations executed by the system 1 according to the first embodiment. The first generator 101, the second generator 102 and the third generator 103 receives the content and generates encoded data respectively by encoding the received content (step S701). The encoded data is sent to storage 104 and stored in storage 104 (step S702).

Selector 154 included in reproduction device 50 selects the encoded data to be sent to delivery device 10 based upon the bandwidth of network 20 or an amount of buffering data (step S703). Sequentially communicator 151 sends a request for delivering the encoded data selected by the selector to delivery device 10 (step S704).

Delivery device 10 accepts a request. Communicator 105 reads the requested segment from storage 104 and sends the segment (step S705). Communicator 151 receives the segment sent from communicator 105 (step S706), and sends the received segment to buffer 152. Buffer 152 buffers the segment (step S707). Finally reproducer 153 reproduces the encoded data buffered by buffer 152 (step S708). The operations from step S703 to S708 are repeatedly executed until the content finishes or reproduction of the content is stopped. The reproduction of the content may be stop according to a command inputted by the user.

In this embodiment, an example that the reproduction device 50 receives the encoded data is described. Delivery device 10 may select the encoded data to be delivered according to timing of the request to change the encoded data.

### Another Example of the First Embodiment

Length of the segment of encoded data C may be the same as encoded data B. The starting time of encoded data C is different from encoded data B (not shown in the drawings). Selector 154 chooses between the encoded data B and C of which the starting time is the closest. To determine which of the subsequent data segments are closer to the first segment, upcoming starting points of the subsequent segments are compared with each other. The earliest one of the second subsequent segments is chosen as closer to the first segment.

As the length of the segment of the encoded data C become shorter, the quality in coding efficiency of the encoded data C decreases. According to the example, the length of the segment of the encoded data C is the same as the encoded data B, so the encoded data C can be encoded in similar quality to the encoded data B can be encoded in coding efficiency.

According to this example, coding efficiency of the content to be delivered can be maintained. Also the latency time to switch the bit rate of the content can be reduced.

According to the embodiment, the contents to be delivered can maintain coding efficiency, and the latency time to change the bitrate of the contents can be reduced.

### Second Embodiment

In the first embodiment, encoded data A-C are produced by encoding the same content. In the second embodiment, an example that encoded data A is obtained by encoding content different from the content used to encode data B or C is described.

The delivery device 10 receives content, encodes the content, and stores encoded data. The first generator 101 receives first content from an external device and encodes the first content to generate encoded data A. The second generator 102 and the third generator 103 receive second content different from the first content, encode the second content, and generate encoded data B and C, respectively. The segment of encoded data C is shorter than the segment of encoded data B. Additionally encoded data D having a shorter segment than the segment of encoded data A may be generated from the first content.

Selector 154 according to the second embodiment is different in operation from the first embodiment. Selector 154 included in reproduction device 50 selects the content, for example, according to a command inputted by the user. Also selector 154 may select the encoded data according to the meta-information included in the content on reproduction. Selector 154 subsequently selects the encoded data to be reproduced among the encoded data of the selected content. The selector 154 selects the encoded data in the same way as the selector 154 according to the first embodiment.

In the system 1 according to the second embodiment, different from the system 1 according to the first embodiment, the content to be reproduced is selected according to direction inputted by the user. In the same way as the first embodiment, by using encoded data C temporarily, the latency time to switch between the encoded data can be reduced without lengthening the segment of encoded data A and B. Hereby the latency time to switch between the content can be reduced without a reduction in coding efficiency. As with the first embodiment, lengthening the segments of encoded data A and B does not affect the latency time. So by encoding the contents in a longer segment, coding efficiency can be increased.

In the second embodiment, the bit rates of encoded data A, B and C may be set arbitrarily. Encoded data C is reproduced temporarily between encoded data A and B, so the encoded data C has a bit rate lower than that of encoded data A and B. Thereby a quality of the reproduced content can be improved in case that the user views the content without changing the contents.

In the second embodiment, the system 1 reproduces switching between a plurality of content. The plurality of content may be generated the same and be produced from the same content. Typically, captured different parts of the same content may be prepared and encoded. Also if the content is a moving image, the moving images taken from different views may be prepared and encoded. If the content is music, instrumental parts of the music may be prepared and encoded. A captured part of the content and whole part of the content may be inputted to be encoded. Hereby, demand of the user who wants to watch only a portion of the content can be satisfied. Also the latency time to switch the content can be reduced.

Although delivery device 10 and reproduction device 50 according to the first and the second embodiments are connected to each other over the interactive network 20, this arrangement may be changed. For example, delivery device 10 may send the encoded data to reproduction device 50 via terrestrial broadcasting. In such case, communicator 105 included in delivery device 10 receives the encoded data generated by first generator 101, second generator 102 and third generator 103 from storage 104. The encoded data is sent via broadcast wave. Communicator 151 receives the broadcast wave, and the encoded data is selected by selector 154. In a system like broadcast, the latency time required to switch the content (for example switching between channels) can be decreased without harming coding efficiency, in the same manner as the second embodiment. In such case, communications like UDP multicast may receive the encoded data as a substitute for the broadcast wave.

A delivery device 10 may include a wide variety of recording media (not shown in the drawings). The recording media is, for example, CD, DVD, Blu-ray Disk, or MO. The encoded data generated by the first generator 101, the second generator 102 and the third generator 103 are stored in the recording media (not shown in the drawings) as a substitute for outputting to the storage 104. The communicator 151 receives the encoded data from the recording media, and reproduces the content.

Functions of the delivery and reproduction device according to each embodiment may be by a processor. Hardware implementation of the processor may be an a semiconductor integrated circuit such as a LSI (Large Scale Integration) or an IC (Integrated Circuit) chip set, or a customizable electronic circuit such as an FPGA (field programmable gate array). The semiconductor integrated circuit is implemented so as to process functions described above. The processor may be a computer (not shown) including include a controller, such as a CPU (a microprocessor, a Central Processing Unit) which controls the overall device, main storage such as a ROM (Read Only Memory) or a RAM (Random Access Memory) which stores various data or programs, auxiliary storage such as HDD (Hard Disk Drive) or CD (Compact Disk) drive which stores various data or programs, and a bus 7 connecting these elements. The CPU reads the program stored in main memory and executes the program. Thereby, the computer works as a special purpose computer described above.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. : An encoding method, comprising:
encoding content into first, second and third data, the first data having a segment length longer than a segment length of the third data; and
transmitting the encoded content including:
transmitting the first data,
switching transmission of the first data to the third data,
transmitting the third data, and
switching transmission of the third data to the second data.

2. The encoding method of claim 1, comprising:
determining if a start time of a next segment of the second data is within a predetermined threshold of time to an end time of a segment of the first data being transmitted;
switching transmitting the first data to transmitting the second data if the timing is within the threshold; and
switching transmitting of first data to third data if the timing is not within the threshold.

3. The encoding method of claim 1, comprising:
the first data having a bit rate higher than a bit rate of the second data.

4. The encoding method of claim 1, comprising:
the first data having a bit rate lower than a bit rate of the second data.

5. The encoding method of claim 1, comprising:
the third data having a bit rate between bit rates of the first and second data.

6. The encoding method of claim 1, comprising:
the first, second and third data corresponding to different content.

7. An encoding method, comprising:
encoding content into first, second and third data, the first data having a segment with a first start time, the second data having a segment with a second start time and the third data having a segment with a start time different from the second start time;
transmitting the first data;
determining which of a start time of a next segment of the second and third data is closer to and end time of a segment of the first data being transmitted; and
switching transmitting of first data to second or third data, whichever is closer in time.

8. The encoding method of claim 7, comprising:
the first data having a bit rate higher than a bit rate of the second data.

9. The encoding method of claim 7, comprising:
the first data having a bit rate lower than a bit rate of the second data.

10. The encoding method of claim 7, comprising:
the third data having a bit rate between bit rates of the first and second data.

11. The encoding method of claim 7, comprising:
the first, second and third data corresponding to different content.

12. An encoding apparatus, comprising:
a first encoder to encode content to produce first data having a first segment length;
a second encoder to encode the content to produce second data having a second segment length;
a third encoder to encode the content to produce third data having a third segment length shorter than the first segment length; and
a data transmitter configured to:
transmit the encoded content using the first to third data, and determine which of a start time of a next segment of the second and third data is closer to and end time of a segment of the first data being transmitted; and
switch transmitting of first data to second or third data, whichever is closer in time.

13. The encoding apparatus of claim 12, wherein the first data has a bit rate higher than a bit rate of the second data.

14. The encoding apparatus of claim 12, wherein the first data has a bit rate lower than a bit rate of the second data.

15. The encoding apparatus of claim 12, wherein the third data has a bit rate between bit rates of the first and second data.

16. The encoding apparatus of claim 12, wherein the first, second and third data correspond to different content.
